(19) United States
(12) Patent Application Publication
(10) Pub. No.: US 2024/0369355 A1
(43) Pub. Date: Nov. 7, 2024

(54) DEVICE, SYSTEM AND METHOD FOR DETERMINING DEGRADATION

(71) Applicant: Nippon Telegraph and Telephone Corporation, Tokyo (JP)

(72) Inventors: Masaki NAKAMORI, Musashino-shi, Tokyo (JP); Nazuki HONDA, Musashino-shi, Tokyo (JP); Mitsuyasu YANAGIDA, Musashino-shi, Tokyo (JP); Yukihiro GOTO, Musashino-shi, Tokyo (JP)

(21) Appl. No.: 18/293,408

(22) PCT Filed: Aug. 25, 2021
(86) PCT No.: PCT/JP2021/031228

§ 371 Date: Jan. 30, 2024

(51) Int. Cl. G01B 11/30; G01N 21/3581; G01N 21/952

(52) U.S. Cl. CPC G01B 11/306; G01N 21/3581; G01N 21/952

(57) ABSTRACT

An object of the present disclosure is to enable inspection of an invisible portion covered with a cover or the like with a quantitative index even with backlight. The present disclosure provides a device and a method for determining deterioration of a metal structure having an uneven structure. An image indicating unevenness of a surface of the metal structure measured using a terahertz wave is acquired. The deterioration of the metal structure is determined by analyzing the acquired image.

### TECHNICAL FIELD

The present disclosure relates to a deterioration determination device, system, and method.

### BACKGROUND ART

To provide communication services, external facilities such as utility poles are installed, and thus inspection work for the external facilities is very important. For the inspection work, suspension wires and the branch wires fulfill roles of supporting loads of cables to prevent breaking and supporting tensions so that the utility poles do not become unbalanced. The suspension wires have structures in which a plurality of steel strands such as seven strands are twisted, and the surfaces are plated with zinc or the like. Therefore, weather resistance to environments is very high, but there will be deterioration in wires due to the progress of corrosion after installation of such wires outdoors over a long time. When the wires are disconnected, the cables are disconnected, and secondary damage occurs due to the influence of communication services and occurrence of unbalanced loads of the utility poles. Accordingly, such inspections are very important.

In methods of inspecting suspension wires and branch wires, local workers have determined deterioration by visual observation. However, in recent years, efficiency has been improved using images or the like. In the inspections in which images re used, deterioration is determined mainly by making a comparison with inspection indexes for the current states by color. There are previous studies on methods of viewing rust corrosion in images.

### CITATION LIST

### Non Patent Literature

Non Patent Literature 1: V. Bondada, D. K. Pratihar, and C. S. Kumar, “Detection and quantitative assessment of corrosion on pipelines through image analysis,” Procedia Computer Science, vol. 133, pp. 804-811, 2018.
Non Patent Literature 2: C. Galamhos, J. Matas, and J. Kittler, “Progressive probabilistic Hough transform for line detection”, in Proc. Conf. Computer Society Conference on Computer Vision and Pattern Recognition, vol. 1, pp. 554-560, 1999.

### SUMMARY OF INVENTION

### Technical Problem

In the determination method of the related art in which images are used, there is a problem that deterioration at the time of backlight may not be determined and invisible portions covered with covers or the like may not be determined. Further, there is no quantitative index for a determination method, and there is a problem that a determination result varies depending on an inspector.

### Solution to Problem

The inventors have devised a deterioration determination method in which images captured by terahertz waves are used. According to the present disclosure, since images captured by terahertz waves are used, invisible portions covered with covers or the like can be inspected even with backlight. According to the present disclosure, since determination can be performed based on image analysis, the determination can be performed with a quantitative index. Further, according to the present disclosure, because of a determination method capable of obtaining a constant determination result regardless of the presence or absence of a cover, it is possible to obtain a constant determination result with a quantitative index in an invisible portion.

Specifically, according to an aspect of the present disclosure, in a deterioration determination device and a deterioration determination method,
a deterioration determination device determines deterioration of a metal structure having an uneven structure.

An image indicating unevenness of a surface of the metal structure measured using a terahertz wave is acquired; and
deterioration of the metal structure is determined by analyzing the acquired image.

Specifically, according to another aspect of the present disclosure, a deterioration determination system includes:
the deterioration determination device according to the aspect of the present disclosure;
a measurement unit configured to measure unevenness of a surface of a metal structure; and
a mechanism unit configured to measure unevenness of the surface of the metal structure by moving the measurement unit in a longitudinal direction of the metal structure and a rotational direction perpendicular to the longitudinal direction.

The deterioration determination device determines deterioration of the metal structure using an image obtained from data measured by the measurement unit.

The deterioration determination device according to the aspect of the present disclosure can also be implemented by a computer and a program. The program can be recorded in a recording medium and can also be provided via a network. The program according to the aspect of the present disclosure is a program causing a computer to implement each functional unit included in the deterioration determination device according to the aspect of the present disclosure, and is a program causing the computer to execute each step included in the deterioration determination method executed by the deterioration determination device according to the aspect of the present disclosure.

### Advantageous Effects of Invention

According to the present disclosure, an invisible portion covered with a cover or the like can be inspected with a quantitative index even with backlight.

### BRIEF DESCRIPTION OF DRAWINGS

FIG. 1 is a diagram illustrating an example of a configuration of a deterioration determination system.

FIG. 2 is an exemplary flowchart of a measurement unit and a mechanism unit.

FIG. 3 is an exemplary flowchart of an image processing unit.

FIG. 4 is a diagram illustrating an example of image processing.

FIG. 5 is a diagram illustrating an example of binarization and straight line detection.

FIG. 6 is an exemplary flowchart of a determination processing unit.

FIG. 7 is a diagram illustrating an example of a determination process.

FIG. 8 is a diagram illustrating an example of a configuration of a mechanism unit.

FIG. 9 is a diagram illustrating an example of a configuration of a measurement unit.

### DESCRIPTION OF EMBODIMENTS

Hereinafter, embodiments of the present disclosure will be described in detail with reference to the drawings. The present disclosure is not limited to the embodiments to be described below. These embodiments are merely exemplary, and the present disclosure can be carried out in forms of various modifications and improvements based on the knowledge of those skilled in the art. Components having the same reference numerals in the present specification and the drawings are the same components.

### First Embodiment

Examples according to the present disclosure will be described below.

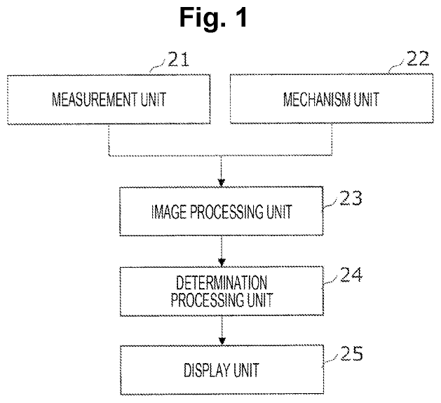

FIG. 1 is a diagram illustrating a configuration of a deterioration determination system according to the present disclosure. The deterioration determination system according to the present disclosure includes a measurement unit 21, a mechanism unit 22, an image processing unit 23, a determination processing unit 24, and a display unit 25. The image processing unit 23 and the determination processing unit 24 function as the deterioration determination device according to the present disclosure, and can be implemented by a computer and a program, and the program is able to be recorded on a recording medium and also be provided through a network.

The measurement unit 21 measures a measurement target using a terahertz wave. The mechanism unit 22 changes a relative position of the measurement unit 21 with respect to a measurement target and performs planar measurement of the measurement target. As described above, according to the present disclosure, the measurement unit 21 and the mechanism unit 22 cooperate to perform the planar measurement of the measurement target using the terahertz wave, and obtain images indicating unevenness of a surface of the measurement target. The image processing unit 23 analyzes the images obtained by the measurement unit 21 and the mechanism unit 22.

The determination processing unit 24 determines deterioration of the measurement target based on an analysis result of the image processing unit 23.

The display unit 25 displays the result of the determination performed by the determination processing unit 24.

Here, the measurement target is a metal structure having an uneven structure. In the present disclosure, in order to image the uneven structure on the surface of such a metal structure, the uneven structure on the surface of the metal structure is measured using a terahertz wave. Accordingly, according to the present disclosure, it is possible to acquire an image indicating the unevenness of the surface of the metal structure even in an invisible portion covered with a cover or the like. Hereinafter, in the embodiment, an example in which the metal structure is a linear structure in which a plurality of metal wires such as a suspension wire or a branch wire are twisted together will be described.

Specifically, the measurement unit 21 changes the relative position of the measurement target with respect to the measurement unit 21 while irradiating the surface of the metal structure with the terahertz wave. For example, when the measurement target is a linear structure, the measurement unit 21 is moved in parallel in the longitudinal direction of the linear structure, and the measurement unit 21 is moved in a direction perpendicular to the longitudinal direction. In the present disclosure, the direction of parallel movement is referred to as a parallel direction, and the direction perpendicular to the longitudinal direction is referred to as a rotational direction.

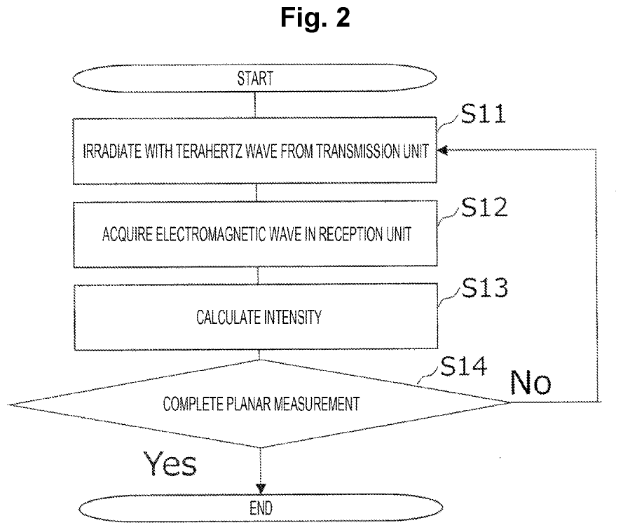

FIG. 2 is a flowchart illustrating operations of the measurement unit 21 and the mechanism unit 22.

The measurement unit 21 irradiates the measurement target with the terahertz wave from the transmission unit (S11), and acquires an electromagnetic wave in the reception unit (S12). Here, the electromagnetic wave acquired by the reception unit includes an arbitrary electromagnetic wave generated by irradiating the measurement target with the terahertz wave. Then, reflection intensity of the terahertz wave with which the measurement target is irradiated is calculated (S13).

The mechanism unit 22 performs this series of measurement using the measurement unit 21 planarly and repeats the measurement until the planar measurement is completed (S14). Accordingly, image data indicating a distribution of the reflection intensity of the terahertz wave obtained by the measurement unit 21 is obtained. The image processing unit 23 processes the finally obtained image data.

Here, the reflection intensity of the terahertz wave indicates unevenness of the surface of the measurement target. When the measurement target is a linear structure in which a plurality of metal wires are twisted, the terahertz wave is reflected from the surface of each metal wire. Thus, the image processing unit 23 detects a straight line using a region where reflection intensity is high in the image. Accordingly, the image processing unit 23 can detect a straight line corresponding to the metal wire provided in the linear structure.

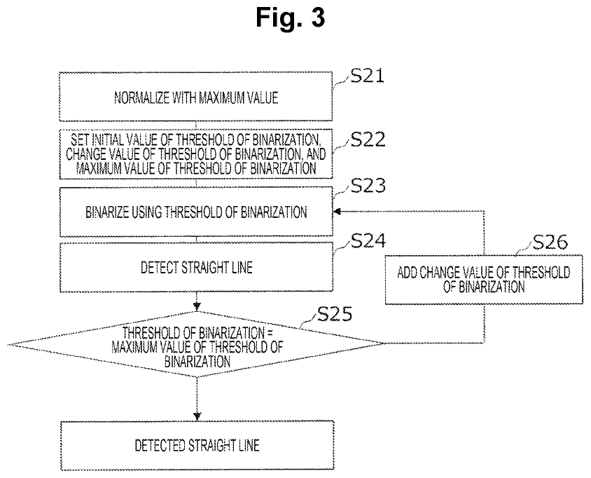

Specifically, the image processing unit 23 performs processing as in the flowchart illustrated in FIG. 3. Data obtained as a result of the planar measurement is normalized with a maximum value (S21), and then is binarized using a threshold of binarization (S23). As the threshold in step S23, a single value may be used or a plurality of values may be prepared. When the plurality of values are used, an initial value of the threshold of binarization, a change value of the threshold of binarization, and a maximum value of the threshold of binarization are set (S22).

Here, in the case of measuring the reflection intensity of the terahertz wave on the surface of the measurement target in the planar measurement, the normalization in step S21 normalizes the gradation of the image with the maximum value of the reflection intensity. Note that the normalization in step S21 is not limited to the maximum value of the reflection intensity, and can be performed with an arbitrary value according to the data obtained as a result of the planar measurement.

The image processing unit 23 performs straight line detection using the binarized image (S24). Although any algorithm for straight line detection is used, for example, a progressive probabilistic Hough transform algorithm (for example, see Non Patent Literature 2: hereinafter referred to as PPHT algorithm) can be used. Here, when a plurality of thresholds are set as in step S22, straight line detection is performed for each threshold (S25 and S26).

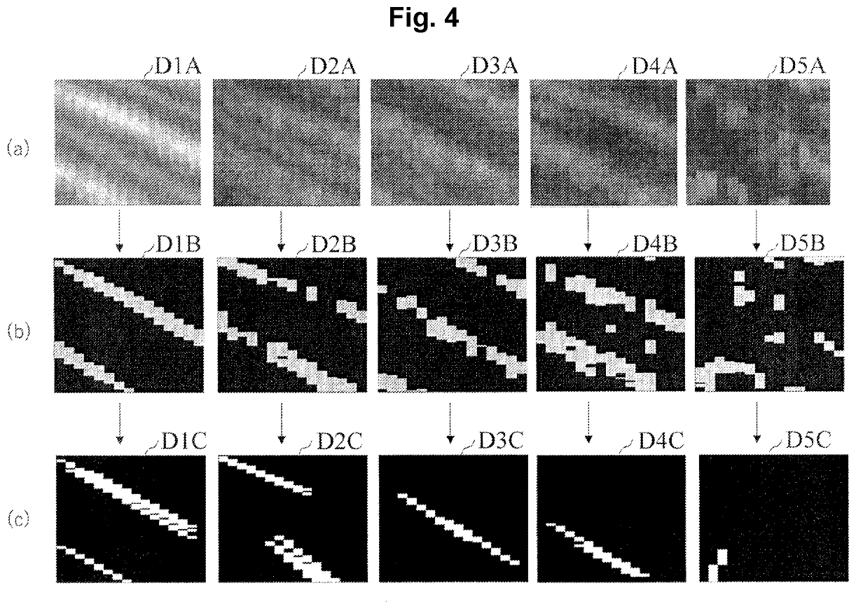

FIG. 4 illustrates an example of the processing described in FIG. 3. Original data illustrated in FIG. 4 (a) is an example of an image acquired by the measurement unit 21. This is an example in which five measurement targets are measured by the measurement unit 21, and the horizontal direction is the parallel direction and the vertical direction is the rotational direction. In the present disclosure, five samples from first to fifth samples are used as an example of the measurement target. Original data D1A is the first sample which is close to a new sample without deterioration, original data D5A is a fifth sample in which the deterioration has progressed the most among the five samples. The deterioration progresses as the number increases.

Examples in the binarization of the original data D1A, D2A, D3A, D4A, and D5A with a certain threshold based on the flow of FIG. 3 are the images D1B, D2B, D3B, D4B, and D5B after the binarization processing illustrated in FIG. 4 (b). Further, examples of the result obtained by performing the straight line detection processing are images D1C, D2C, D3C, D4C, and D5C corresponding to the post-straight line detection illustrated in FIG. 4 (c).

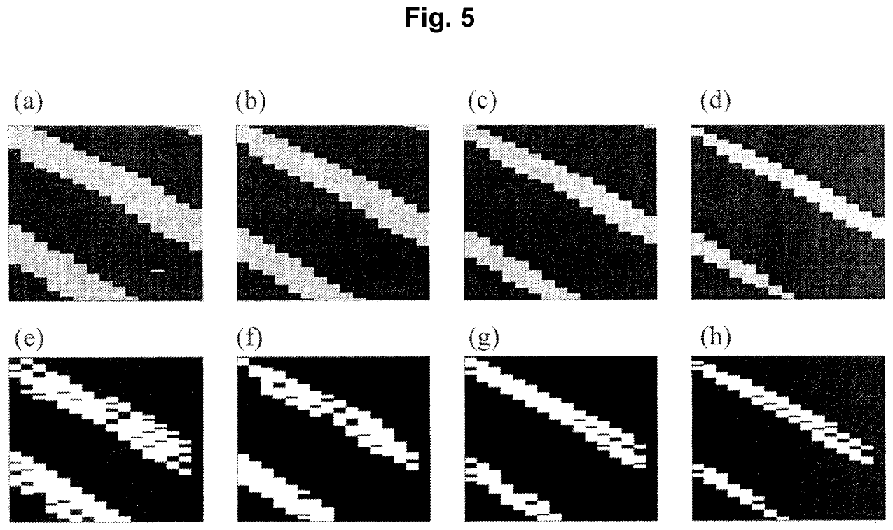

FIG. 5 illustrates a result of an example of the repeated processing when the threshold of binarization is changed in steps S25 and S26 in the flow of FIG. 3. FIG. 5 (a) corresponds to a part of the image D1B of FIG. 4. FIG. 5 (e) is an image obtained by performing the straight line detection from the image after the binarization processing illustrated in FIG. 5 (a). By changing the threshold of binarization on the image after the binarization processing illustrated in FIG. 5 (a), the images after the binarization processing illustrated in FIGS. 5 (b) to 5 (d) are obtained. FIGS. 5 (f) to 5 (h) are images obtained by performing the straight line detection from the images after the binarization processing illustrated in FIGS. 5 (b) to 5 (d), respectively. As described above, the image processing unit 23 may repeatedly perform the binarization and the straight line detection while changing the threshold of binarization for the measurement target.

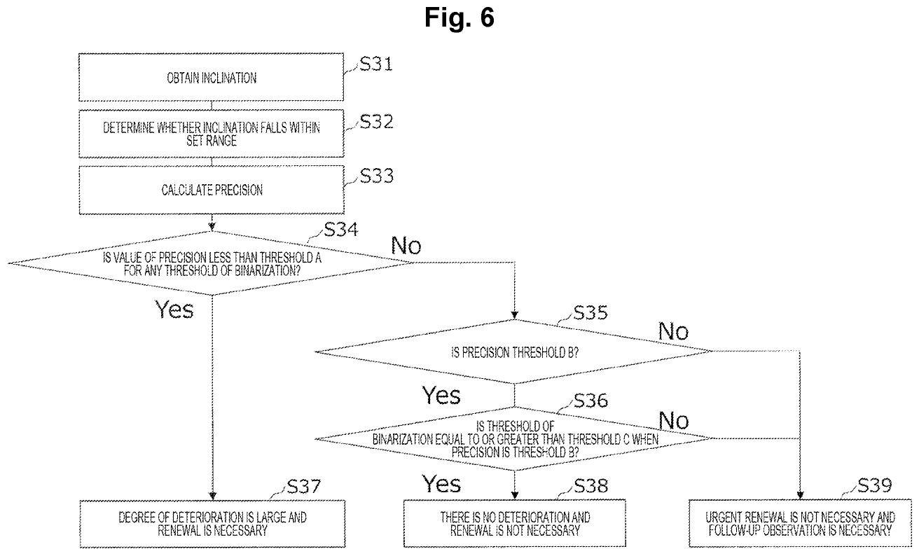

FIG. 6 illustrates a flowchart of the determination processing unit 24. When the measurement target is a linear structure in which a plurality of metal wires are twisted, the metal wires are arranged at an inclination determined for each measurement target in the longitudinal direction of the linear structure, that is, the horizontal direction. Accordingly, according to the present disclosure, the inclination is obtained with respect to the straight line output by the image processing unit 23 (S31). In order to determine whether the inclination is caused by the twisted structure of the measurement target, a range of the inclination value is set, and it is determined whether the inclination value falls within the range (S32). Since the straight line of which an inclination falls within the set range is a straight line corresponding to a metal wire, a correct answer is obtained.

As the deterioration of the metal wire progresses, the straight line corresponding to the metal wire is not clear as illustrated in FIGS. 4 (b) and 4 (c). Accordingly, according to the present disclosure, a straight line corresponding to a metal wire is extracted from an image, and deterioration of a measurement target is determined using the extracted number, that is, the number of correct answers. Specifically, a precision is defined and calculated as a ratio between the total number of detected straight lines and the number of correct answers (S33). Here, as illustrated in step S22 of FIG. 3, when there are a plurality of thresholds of binarization, the precision is calculated for each threshold.

Next, the deterioration of the measurement target is determined based on the calculated threshold of binarization and the precision. When the precision is less than an arbitrary threshold A (Yes in S34), it is determined that the degree of deterioration is large and it is necessary to renew a facility urgently (S37). In addition, when the precision is equal to or greater than the threshold A (No in S34), the precision is a threshold B (Yes in S35), and the threshold of binarization is equal to or greater than a threshold C (Yes in S36), it can be determined that there is no deterioration and it not necessary to renew the facility (S38). Further, when the precision does not reach the threshold B (No in S35) or when the precision reaches the threshold B and the threshold of binarization does not exceed the threshold C (No in S36), it can be determined that urgent renewal is not necessary despite deterioration and follow-up observation is necessary (S39).

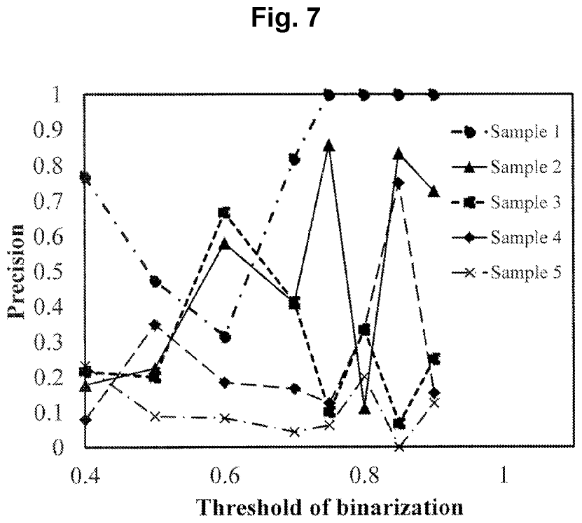

FIG. 7 illustrates an example of a relationship between thresholds of binarization and a precision using the precision calculated in step S33 of FIG. 6. In the example, for example, five samples illustrated in FIG. 4 are used. In the drawing, Sample 1 is a first sample, Sample 2 is a second sample, Sample 3 is a third sample, Sample 4 is a fourth sample, and Sample 5 is a fifth sample.

As illustrated in FIG. 7, in the first sample, the precision increases when the threshold of binarization is 0.4 and 0.7 or more. On the other hand, in the fifth sample, the precision does not increase even when the threshold of binarization is adjusted. As described above, as the deterioration progresses, a high precision is not detected even when the threshold of binarization is adjusted.

Accordingly, according to the present disclosure, as illustrated in the flow of FIG. 6, the threshold of binarization is adjusted, and the deterioration of the measurement target is determined based on the precision after the adjustment of the threshold of binarization. Here, the threshold of the precision for determining deterioration of the measurement target can be determined for each measurement target by acquiring a relationship as illustrated in FIG. 7 in advance using a sample of the measurement target. For example, FIG. 6 illustrates an example in which the thresholds of the precision are two types of A and B, but these thresholds can be set to any number for each measurement target.

For example, in the flow illustrated in FIG. 6, when the thresholds A, B, and C are numerically limited to 0.5, 0.9, and 0.6, it can be determined that the first sample does not degrade, the second, third, and fourth samples are required to be followed up, and the fifth sample is required to be renewed in the example of FIG. 7 according to the determination flow.

Note that the following parameters were used to calculate the precision.
Threshold of PPHT Algorithm: 5 to 20
minLineLngth: 5 to 20
maxLineGap: 1 to 3

Here, the thresholds of the PPHT algorithm are thresholds required to be regarded as straight lines. In the Hough transform in the PPHT algorithm, straight lines passing through each point of a binarized image are counted. When there is a straight line passing through a plurality of points, the straight line is counted redundantly by the number of points. That is, a straight line counted redundantly considerably is determined to be a straight line in the image. Threshold indicates a threshold of the redundantly counted value. A straight line with a value larger than the threshold is detected as a straight line, and a straight line with a value equal to or smaller than the threshold is not detected.

minLineLngth is a parameter for designating the length (the number of pixels) of a straight line to be detected. A straight line smaller than this value is not detected. maxLineGap is a maximum length allowed when two straight lines are regarded as one straight line. Two straight lines smaller than this value are regarded as one straight line.

As described above, according to the embodiment, automatic and quantitative determination are enabled regardless of presence or absence of a cover. Therefore, an advantageous effect of improving the efficiency of an inspection work and eliminating uncertainty of a diagnosis result by an inspector is expected.

### Second Embodiment

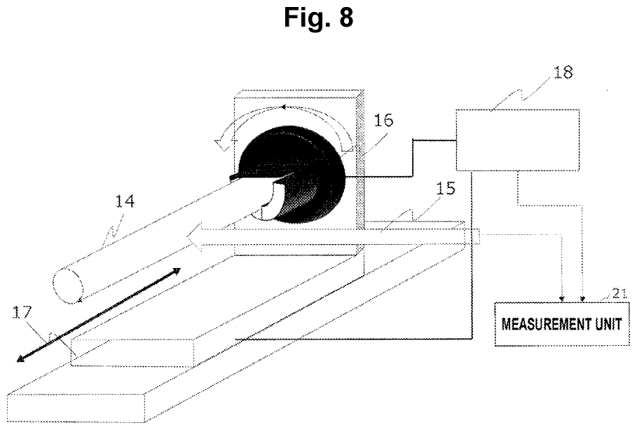

FIG. 8 illustrates a configuration example of the mechanism unit 22. In this example, in order to measure a sample 14 of a suspension wire of a measurement target, a moving stage 17 that translates the sample 14 in the longitudinal direction of the suspension wire and a rotation stage 16 that rotates the sample 14 perpendicular to the longitudinal direction of the suspension wire are provided. The rotation stage 16 is fixed to the moving stage 17. The mechanism unit 22 includes a control unit 18 that controls the rotation stage 16 and the moving stage 17.

In a state where the sample 14 is fixed to the rotation stage 16, the measurement unit 21 acquires an electromagnetic wave generated in the sample 14 by irradiating the sample 14 with a terahertz wave. When the control unit 18 rotates the rotation stage 16, the measurement unit 21 can acquire the electromagnetic waves reflected at different positions in the rotational direction of the sample 14. The control unit 18 can acquire the electromagnetic waves reflected at different positions in the parallel direction of the sample 14 by moving the moving stage 17. By moving the position irradiated with the terahertz wave in this manner, planar image data having a width in the parallel direction and the rotational direction as illustrated in FIG. 4 can be acquired.

As another embodiment, it is also possible to adopt a method of performing planar scanning using a galvanometer mirror or the like.

Further, in the embodiment, the example in which the mechanism unit 22 includes the rotation stage 16 that rotates the sample 14 has been described, but the present disclosure is not limited thereto. For example, the rotation stage 16 may rotate the transmission unit and the reception unit included in the measurement unit 21. Accordingly, it is possible acquire image data of any measurement target such as a suspension wire and a branch wire laid outdoors.

### Third Embodiment

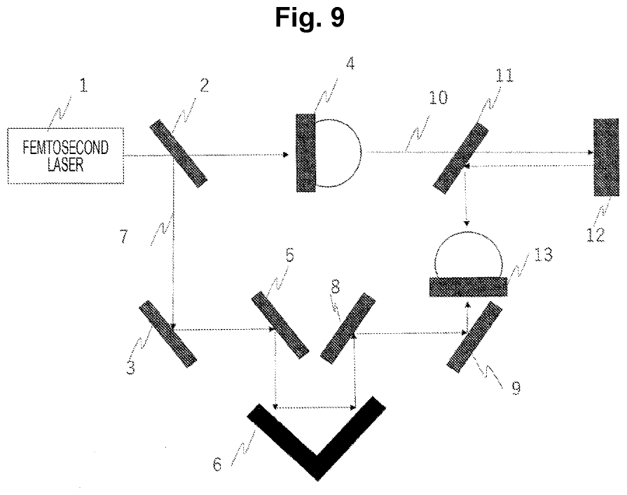

FIG. 9 illustrates an exemplary embodiment of a transceiver unit of a terahertz wave in the measurement unit 21. Here, a method of generating a terahertz wave using a femtosecond laser and receiving the terahertz wave using time domain spectroscopy of the terahertz wave is illustrated. A femtosecond laser 1 emits pulsed light of a terahertz wave, and the laser beam splitter 2 splits the pulsed light into two pieces of light. One piece of split light (probe light) is incident on a light receiving unit 13 via the mirrors 3, 5, 8, and 9 and an optical delay mechanism 6. The other piece of split light (pump light) is emitted from the transmission unit 4, is reflected by the measurement target 12, and then is received by the light receiving unit 13. Accordingly, the measurement unit 21 can measure reflection intensity at the measurement target 12.

The measurement unit 21 is not limited to the embodiment, and any configuration capable of acquiring image data indicating unevenness of the surface of the measurement target as illustrated in FIG. 4 using a terahertz wave can be adopted.

### INDUSTRIAL APPLICABILITY

The present disclosure can be applied to information and communication industries.

### REFERENCE SIGNS LIST

1 Femtosecond laser for excitation
2 Laser beam splitter
3 Mirror
4 Transmission unit
5 Mirror
6 Optical delay mechanism for sampling
7 Optical path of probe light
8 Mirror
9 Mirror
10 Optical path of terahertz wave
11 Beam splitter of terahertz wave
12 Measurement target
13 Reception unit
14 Sample
15 Incident terahertz wave
16 rotation stage
17 Moving stage
18 Control unit
21 Measurement unit
22 Mechanism unit
23 Image processing unit
24 Determination processing unit
25 Display unit

1. A deterioration determination device, comprising one or more processors, configured to determine deterioration of a metal structure having an uneven structure, the deterioration determination device configured to:
acquire an image indicating unevenness of a surface of the metal structure measured using a terahertz wave; and
determine deterioration of the metal structure by analyzing the acquired image.

2. The deterioration determination device according to claim 1,
wherein the metal structure is a linear structure, and
the deterioration determination device is configured to:
a detect straight lines from the image;
extract the straight lines corresponding to metal wires included in the image by using an inclination of the straight lines; and
determine deterioration of the linear structure using the number of extracted straight lines.

3. The deterioration determination device according to claim 2,
wherein the image is an image indicating reflection intensity of the terahertz wave with which the metal structure is irradiated, and
the deterioration determination device is configured to detect the straight lines using a region where a reflection intensity is high in the image.

4. The deterioration determination device according to claim 3,
wherein the deterioration determination device is configured to:
normalize the image by using one threshold or a plurality of thresholds determined with the reflection intensity;
binarize each of the normalized images; and
detect the straight lines by using the plurality of binarized images.

5. The deterioration determination device according to claim 2, wherein the deterioration determination device is configured to:
calculate a precision of the linear structure using a total number of straight lines detected from the image and the number of straight lines corresponding to metal wires extracted from the image; and
determine deterioration of the linear structure using the precision.

6. The deterioration determination device according to claim 2, wherein progressive probabilistic Hough transform is used to detect the straight lines, and
a threshold of the progressive probabilistic Hough transform is 5 or more and 20 or less.

7. A deterioration determination system comprising:
the deterioration determination device according to claim 1;
a measurement unit, comprising one or more processors, configured to measure unevenness of a surface of the metal structure; and
a mechanism unit, comprising one or more processors, configured to measure unevenness of the surface of the metal structure by moving the measurement unit in a longitudinal direction of the metal structure and a rotational direction perpendicular to the longitudinal direction,
wherein the deterioration determination device configured to determine deterioration of the metal structure using an image obtained from data measured by the measurement unit.

8. A deterioration determination method of determining deterioration of a metal structure having an uneven structure, the method comprising:
acquiring an image indicating unevenness of a surface of the metal structure measured using a terahertz wave; and
determining deterioration of the metal structure by analyzing the acquired image.
